(19) United States
(12) Patent Application Publication
(10) Pub. No.: US 2004/0032962 A1
(43) Pub. Date: Feb. 19, 2004

(54) Bone conducting hearing aid

(76) Inventor: Patrik Westerkull, Hovas (SE)

Correspondence Address: SWIDLER BERLIN SHEREFF FRIEDMAN, LLP, 3000 K STREET, NW, BOX IP, WASHINGTON, DC, 20007, US

(21) Appl. No.: 10/296,978

(22) PCT Filed: May 31, 2001
(86) PCT No.: PCT/SE01/01229

(30) Foreign Application Priority Data
Jun. 2, 2000 (SE) 0002071-9

(51) Int. Cl. H04R 25/00

(52) U.S. Cl. 381/151

(57) ABSTRACT

The invention relates to a hearing aid device of the bone conduction type, i.e. a hearing aid device in which the sound is mechanically transmitted via the skull bone directly into the inner ear of a person with impaired hearing. The hearing aid device is divided into an implantable part (5) which comprises a vibrator (7) for generating vibrations correponding to the received sound information and an external part (1) with microphone (7) and electronic circuitry (3). The entire implantable part (5), including the vibrator (7), is housed in a unit which is arranged partly outside the skull bone and anchored by means of osseointegration. The power to the implantable part (5) is transmitted by induction from the external part (1) when the device is used.

The present invention relates to a hearing aid device of the bone conduction type, i e a hearing aid device by which the sound is transmitted via the skull bone directly to the inner ear of a person with impaired hearing. The hearing aid device is divided into an implantable part which comprises a vibrator for generating vibrations in response to the received sound information and an external part with a microphone and electronic,circuitry.

For persons with impaired hearing, the hearing aid devices mainly used today are those based on the principle that the sound is amplified and fed into the auditory meatus and stimulates the eardrum from the outside. In order to prevent feedback problems in these devices, the auditory meatus is almost completely plugged by a hearing plug or by the hearing aid device itself. This causes the user a feeling of pressure, discomfort, and sometimes even eczema. In some cases it even causes the user problems like running ears due to chronic ear inflammations or infections in the auditory canal.

For persons who cannot benefit from traditional, air conduction hearing aids due to such problems that have been described here it is previously known to use hearing aids which leave the auditory meatus free, see for instance U.S. Pat. No. 5,411,467 and U.S. Pat. No. 5,318,502 which hearing aids are both connected to the middle ear. Such a connection, however, requires a surgical operation in the middle ear which is a relatively complicated procedure.

By U.S. Pat. No. 5,282,858 and U.S. Pat. No. 4,988,333 it is also previously known to install a part of the hearing aid device on the middle ear bones. Although such a solution leaves the auditory meatus free, it nevertheless gives rise to an extensive surgical installation proc dure on the middle ear bones. These types of hearing aids have therefore not been used to any large extent.

However, there are other types of sound transmitting hearing aids on the market, i e bone anchored hearing aids which mechanically transmit the sound information to a persons inner ear via the skull bone by means of a vibrator. The hearing aid device is connected to an implanted titanium screw installed in the bone behind the ear and the sound is transmitted via the, scull bone to the cochlea (inner ear), i e the hearing aid works irrespective of a disease in the middle ear or not. The bone anchoring principle means that the skin is penetrated which makes the vibratory transmission very efficient.

This type of hearing aid device has been a revolution for the rehabilitation of patients with certain types of impaired hearing. It is very convenient for the patient and almost invisible with normal hair styles. It can easily be connected to the implanted titanium fixture by means of a bayonet coupling or a snap in coupling. One example of this type of hearing aid device is described in U.S. Pat. No. 4,498,461 and it is also referred to the BAHA® bone anchored hearing aid marketed by Entific Medical Systems in Göteborg.

Even if the bone conduction hearing aid devices have made it possible for more people to benefit from a satisfactory hearing aid, there are also problems with this type of hearing aid devices. One problem is the permanent skin penetration which requires a good hygienic control and has aesthetic drawbacks. By implanting parts of the apparatus hygienic as well as cosmetic aspects can be improved. Such a construction is described in U.S. Pat. No. 4,904,233. A similar implantable bone anchored apparatus is also described in Hearing by Bone Conduction, Stefan Stenfelt, Chalmers University of Technology, 1999. The problem with these constructions is still that either a permanent skin penetration, a deep surgical operation, is required, or it makes it more difficult to replace the implanted part of the apparatus.

The main object of the present invention is to amplify the sound and convey it via bone conduction into the inner ear without the requirement of a permanent skin penetration, or a high pressure force against the skin or a complicated surgery for the installation. Another object of the invention is to provide a hearing aid device which makes it possible to replace the implantable part without any complicated surgical operation.

According to the invention the implantable part with the vibrator is arranged partly outside the skull bone and anchored by means of osseointegration, whereby the power to the implantable part is transmitted by induction.

According to a preferred embodiment the external part comprises a battery for the power supply of the device, whereby the power to the implantable part is transmitted from the external part by induction when the device is used.

According to an alternative embodiment the implantable part comprises a rechargeable battery for the power supply of the implantable part, which battery is arranged to be recharged by induction from an external power supply unit.

In the following the invention will be described more in detail with reference to the accompanying drawings, in which

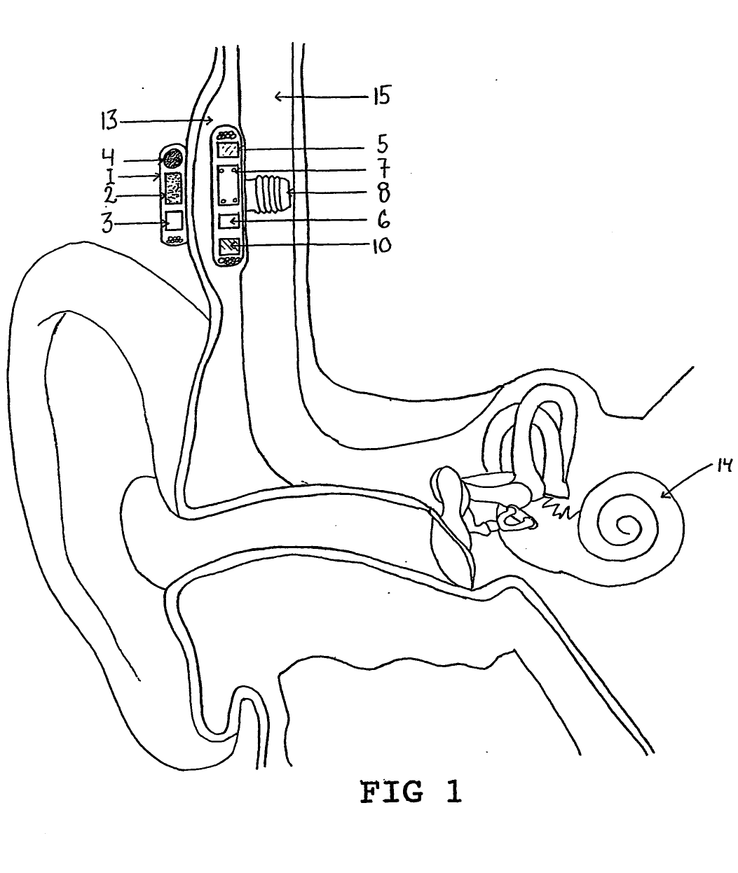

FIG. 1 shows the principle for the hearing aid device,

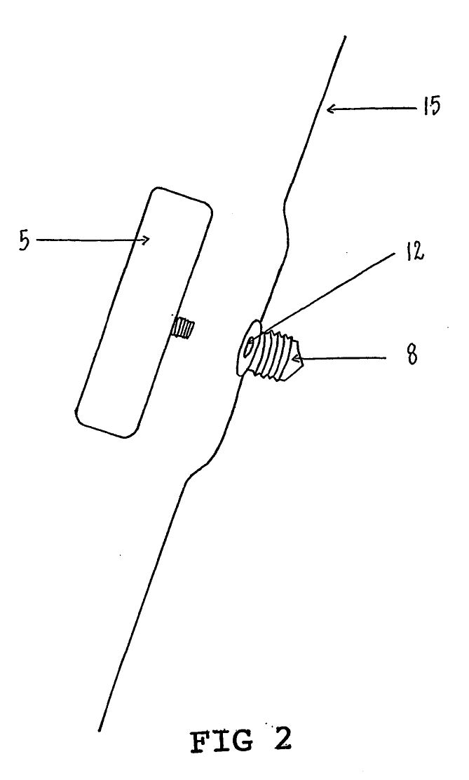

FIG. 2 shows an alternative construction with a separate osseointegrating part,

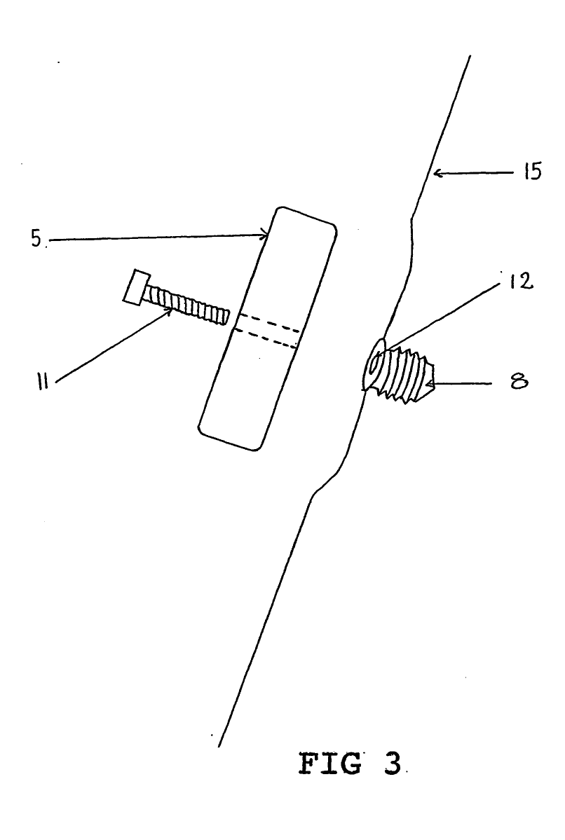

FIG. 3 shows an alternative solution with a separate connection screw,

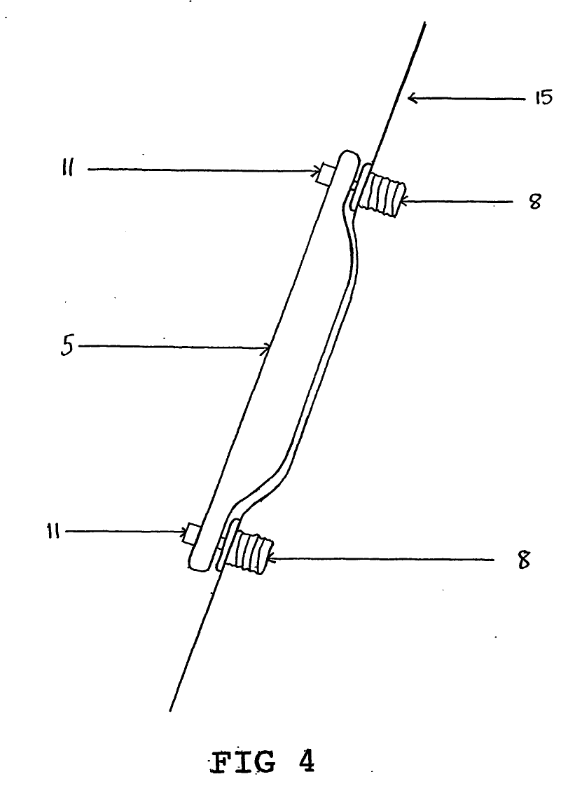

FIG. 4 shows an example having more attachm nt points, and

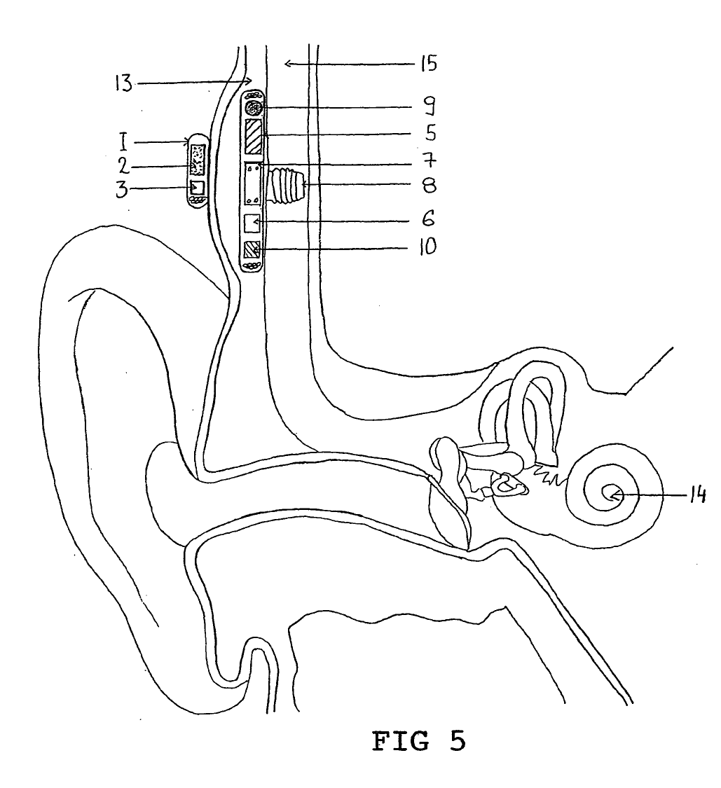

FIG. 5 shows a further variant with implanted power supply.

FIG. 1 shows schematically the auditory organs with external ear, auditory meatus, middle ear and inner ear. The hearing aid device is anchored in the skull bone, preferably in the mastoid bone behind the external ear, and comprises two separate parts, an externally located part 1 and an implanted part 5. The sound is received by the external part 1 via a microphone 2 and is then amplified and filtered in an external electronic circuitry 3 which is power supplied by a battery 4. The amplified signal is transmitted by induction or by any other known means through the skin 13 to the implanted part 5.

To use inductive transmission through the skin of an auditory signal is previously known per se by other types of hearing aid devices, see for instance U.S. Pat. No. 4,606,329. In this case the signal is transmitted to a subcutaneously arranged signal receiving and transmitting component (30) and conveyed via electrodes (34) through a channel in the bone to transmitting means (36) and a vibration generating component (50) adapted to be implanted in any of the small bones in the ossicular chain in the middle ear for vibrating the ossicular chain in response to the received electromagnetic signal. In contrast to such an ossicular stimulating device with the advanced surgery required, in our case the entire implanted part, including the vibrator 7, is housed in a unit, “box”, which is arranged partly outside the skull bone and which makes it exchangeable. The induction transmitted signal is received to the vibrator 7 via electronic circuitry 6 in which the electrical signal is converted into vibrations in the same unit 5. As the implant d unit 5 is anchored into the skull bone by means of an osseointegrated part 8 the vibrations from the vibrator 7 are in our case transmitted to th inner ear 14 by bone conduction without any other surgery required than a minor adaption of the bone tissue surrounding the implanted unit 5.

The osseointegrating part 8 can be a part of the wall of the unit 5 which part of the wall surface allows bone to grow into contact, i e osseointegration. However, at least 20% of the bone adjoining surface should be adapted for non-bone ingrowth in order to facilitate replacement of the implanted unit 5. The implanted unit is preferably arranged in such a way that the osseointegrating part remains anchored in the bone when the unit is replaced. In this case the implantable unit 5 is connected to the osseointegrating part 8 by means of for instance a screw joint.

The design of the osseointegrating part is adapted to the anatomy of the patient in order to more efficiently transmit the vibrations to the skull bone. The osseointegrating part 8 is preferably a titanium screw, a so called fixture. The screw can be made in different lengths so as to match the anatomy of the patient.

Vibrators for bone conduction hearing aid devices are known per se and will therefore not be described in any detail here. One example of such a vibrator with means for damping the resonance frequency of the vibrator is described in SE 85.02426-3. Other suitable vibrators which are encapsulated and rotation symmetrical are described in our co-pending patent applications PCT/SE01/01227 and PCT/SE01/01228.

Independent of which vibrator type is used it should be placed as close to the osseointegrating part as possible in order to optimize the vibratory transmission to the skull bone. The implantable unit is for example made as a circular symmetrical box in which case the vibrator is positioned against the skull bone/titanium fixture, while electronic circuitry and possibly the battery are positioned at the skin side. In the more flat, elongated unit which is illustrated in FIG. 1 the vibrator 7 is located centrally in connection to the osseointegrating, protruding anchoring member 8.

The power which is required for driving the vibrator 7 is transmitted by induction to the implanted unit. Alternatively the power could be stored in a rechargeable battery 9 arranged in the implanted unit 5, see FIG. 5.

The external part 1 is preferably attached by means of magnetic force action between the external and implanted parts. The magnet 10 can be located in the external and/or in the implanted part.

If the implantable unit 5 is provided with a rechargeable battery it is not necessary that the external part is located in connection to the implanted unit. It may be located at any remote place on the body of the user, for instance in the breast-pocket of the user, in which case radio, FM or AM transmission is used.

The implantable unit 5 of the hearing aid device can be designed in such a way that the osseointegrated part 8 is remained in the bone when the implanted unit is replaced. In this case the unit is attached in a-screw hole in the osseointegrated part 8, see FIG. 2. As an alternativ the implantable unit can be attached by means of a separate connection screw 11 screwed into the screw hole in the osseointegrated part 8, see FIG. 3.

The implantable unit can also, alternatively, be attached to a number of osseointegrated parts 8, for instance titanium screws, in the bone, which case is illustrated in FIG. 4.

A further variant is illustrated in FIG. 5 in which the battery for the vibrator is placed in th implantable unit, i e “implanted power supply”. In this case the battery should be rechargeable and recharged by means of induction from an external power supply unit.

The invention is not limited to the examples which have been illustrated here but can be varied within the scope of the accompanying claims.

1. Hearing aid device of the bone conduction type, i e a hearing aid device in which the sound is mechanically transmitted via the skull bone directly into the inner ear of a person with impaired hearing, said hearing aid device being divided into an implantable part which comprises a vibrator for generating vibrations corresponding to the received sound information and an external part with a microphone and electronic circuitry characterized in that the entire implantable part, including the vibrator (7), is housed in a unit (5) which is arranged partly outside the skull bone behind the external ear and anchored by means of osseointegration, whereby the power to the implantable part (5) is transmitted by induction.

2. Hearing aid device according to claim 1 characterized in that the external part (1) comprises a battery (4) for the power supply of the device, whereby the power to the implantable part (5) is transmitted from the external part (1) by induction when the device is used.

3. Hearing aid device according to claim 1 characterized in that the implantable part (5) comprises a rechargeable battery (4) for the power supply of the implantable part (5), which battery is arranged to be recharged by induction from an external power supply unit.

4. Hearing aid device according to claim 3 characterized in that the implantable part (5) comprises at least one osseointegrating part (8), while at least 20% of the bone adjoining surface of the implantable part is adapted to avoid bone ingrowth.

5. Hearing aid device according to claim 4 characterized in that the osseointegrating part comprises a part (B) protruding from the unit (5).

6. Hearing aid device according to claim 5 characterized in that the protruding part (8) is detachable from the unit (5) so that it can be remained in the bone in case of replacement of the implanted part.

7. Hearing aid device according to claim 6 characterized in that the osseointegrating part (8) is provided with a screw hole into which the implantable part can be fastened.

8. Hearing aid device according to claim 7 characterized in that the implantable part (5) is arranged to be fastened by means of a separate connection screw.

9. Hearing aid-device according to claim 6 characterized in that the osseointegrating part comprises a separate titanium screw, a so-called fixture.

10. Hearing aid device according to claim 4 characterized in that implantable part (5) is anchored in the skull bone with more than one osseointegrating part (8), preferably titanium fixtures.

11. Hearing aid device according to claim 1 characterized in that external part (1) is a unit which comprises microphone (2), electronic circuitry (3) and a battery (4) and attached to the skin outside the implanted part (5) by means of a magnet (10).

12. Hearing aid device according to claim 3 characterized in that the external part (1) is a unit which comprises microphone (2) and electronic circuitry (3) and may be located at any place on the body of the user relative to the implanted part (5), for instance in the patient's breast-pocket, in which case the transmission is made by a radio, FM or AM signal.
